(19) United States
(12) Patent Application Publication
(10) Pub. No.: US 2002/0092418 A1
(43) Pub. Date: Jul. 18, 2002

(54) Triplex drilling mud pump fluid driving implement

(76) Inventor: Frederick Hefren, Wichita, KS (US)

Correspondence Address: Kenneth H. Jack, Davis & Jack, L.L.C., 2121 W. Maple, Wichita, KS, 67213, US

(21) Appl. No.: 09/760,246

(22) Filed: Jan. 12, 2001

(51) Int. Cl. F16J 1/00

(52) U.S. Cl. 92/258

(57) ABSTRACT

A fluid driver consisting of a piston support lug having a forward end and a rearward end, a clamp ring engaging disk having a forward end and a rearward end, the rearward end of the piston supporting lug being homogeneously fused with the forward end of the clamp ring engaging disk, the homogeneous fusion extending the rearward end of the piston support lug forwardly from the forward end of the clamp ring engaging disk, the homogeneous fusion resisting fracture, bending, and breakage of the fluid driver.

### FIELD OF THE INVENTION

This invention relates to high powered triplex drilling mud pumps. More particularly, this invention relates to drilling mud driving elements adapted for use in such pumps.

### BACKGROUND OF THE INVENTION

The mechanical power transmission linkage utilized in high powered triplex drilling mud pumps such as is manufactured by Continental EMSCO Company of Houston, Tex., commonly comprises an approximately 2200 horse power electric motor which supplies rapid rotational torque to a speed reducing gear box. In such linkage, the rotary power output of such gear box commonly rotates a crank shaft, such shaft having rotatably mounted thereon the proximal ends of three connecting rods. The distal ends of the three connecting rods are respectively pivotally attached to three parallel slides whose movements are mechanically restricted to reciprocating horizontal sliding motions. The three slides serve the function of converting the rotary motion of the rotor of the electric motor to reciprocating horizontal motion.

Typically, the forward ends of the slides of such triplex pump extend forwardly in the form of rigid forwardly extending shafts. In such linkage, the rearward ends of jointed plunger rods are fixedly and removably attached to the forwardly extending ends of the slides. Rubber plungers or pistons are typically fixedly and removably attached to the forward ends of such jointed plunger rods, such plungers or pistons comprising the structural elements which directly perform work upon drilling mud which pumped by the triplex drilling mud pump. Such plungers or pistons are typically slidably horizontally mounted within rearwardly opening drilling mud filled cylinder.

In operation of the power transmission linkage described above, rotation of the crank shaft imposes horizontal reciprocating motions upon the slides, causing the plungers or pistons in turn to move in a reciprocating fashion within their respective cylinders. As the pistons drive forwardly, approximately 7,500 PSI of pressure is exerted upon drilling mud within the cylinders, driving the drilling mud through check valves, and thence into a drilling mud carrying pipe. Upon rearward return strokes of the pistons, the cylinders are refilled from a source controlled by oppositely oriented check valves. Through the combined actions of the check valves and the reciprocating motions of the pistons, drilling mud is pumped at high pressure for injection to the bottom of an oil well shaft for drilling lubrication.

While the jointed plunger rods of the above described mechanical linkage ostensibly function to facilitate ease of access for interchanging worn or broken pistons, such joints more typically cause such rods to fracture or fail. Driving forces imposed upon such rods tend to focus upon any imprecision in milling of joint surfaces, resulting in uncoordinated rocking actions at and around the joint sites; and ultimately resulting in failure of the joint.

The instant inventive fluid driving implement solves the above problem by allowing the forward end of its rear slide attaching structure to homogeneously forwardly extend its piston attaching structure. Such novel and improved configuration provides heightened resistance to fracture and mechanical failure.

### BRIEF SUMMARY OF THE INVENTION

The instant inventive fluid driving implement preferably comprises a piston support lug having a forward end and a rearward end, and a clamp ring engaging disk having a forward end and a rearward end. According to the invention, the forward end of the clamp ring engaging disk and the rearward end of the piston support lug are homogeneously fused or linked, the homogeneous fusion extending the rearward end of the piston support lug forwardly from the forward end of the clamp ring engaging disk, such homogeneous fusion preferably having a shaft or bar configuration.

Preferably, the inventive fluid driver further comprises piston mounting means interlinking and removably mounting a hollow bored piston over the piston support lug. Preferably, the forward end of the piston support lug is spirally threaded, and preferably the piston mounting means further comprises a flanged piston mounting sleeve whose annular outer surface is closely fitted to the bore of the piston. Preferably, the annular inner surface of the mounting sleeve is closely fitted to the outside diameter of the piston support lug. Also preferably, the piston mounting means further comprises an internally spirally threaded nut for threaded mounting over the forward end of the piston support lug, such nut facilitating the removable mounting of the piston.

Other piston mounting means such as pressure rings, shear pins, and cotter pins may be suitably utilized.

Preferably, the piston is composed of vulcanized rubber and preferably, the forward face of the piston is configured to form a peripheral forwardly extending ridge causing the forward face of the piston to be cupped or concave.

Preferably, the rearward end of the clamp ring engaging disk forms a rearwardly extending reciprocating slide aligning lug for facilitating consistent and secure contact with a reciprocating slide of a triplex drilling mud pump. Also, preferably, the forward end of the clamp ring engaging disk is annularly rearwardly chamfered, such chaffering providing an angled face for pressurized contact with the clamping surfaces of a clamp ring.

The homogeneous forward extension of the piston support lug preferably is milled to form parallel wrench jaw engaging lands. Such lands facilitate application of torque to the spirally threaded nut, for alternate tightening and loosening. All structural elements of the inventive fluid driver other than the piston are preferably composed of hardened steel.

In use of the inventive fluid driver, extreme forwardly directed forces may be applied to the rearwardly by facing surface of the clamp ring engaging disk, and such forces may thereby be accurately and efficiently transmitted forwardly to the piston support lug without fracturing or bending the implement.

Accordingly, it is an object of the present invention to provide a fluid driver for use in a triplex drilling mud pump capable of being repeatedly compressively forwardly driven without bending or fracturing.

It is a further object of the present invention to provide such a fluid driver having opposing parallel lands for convenience in piston removal and reattachment.

Other and further objects, benefits, and advantages of the present invention will become known to those skilled in the art upon review of the Detailed Description which follows, and upon review of the appended drawings.

### BRIEF DESCRIPTION OF THE DRAWINGS

FIG. 1 is an isometric view of the instant inventive fluid driving implement.

FIG. 2 is a sectional view of the implement depicted in FIG. 1, as indicated in FIG. 1.

FIG. 3 is a side view of the implement depicted in FIG. 1, the implement of FIG. 3 shown representationally in its intended triplex drilling mud pump environment.

### DETAILED DESCRIPTION OF THE PREFERRED EMBODIMENT

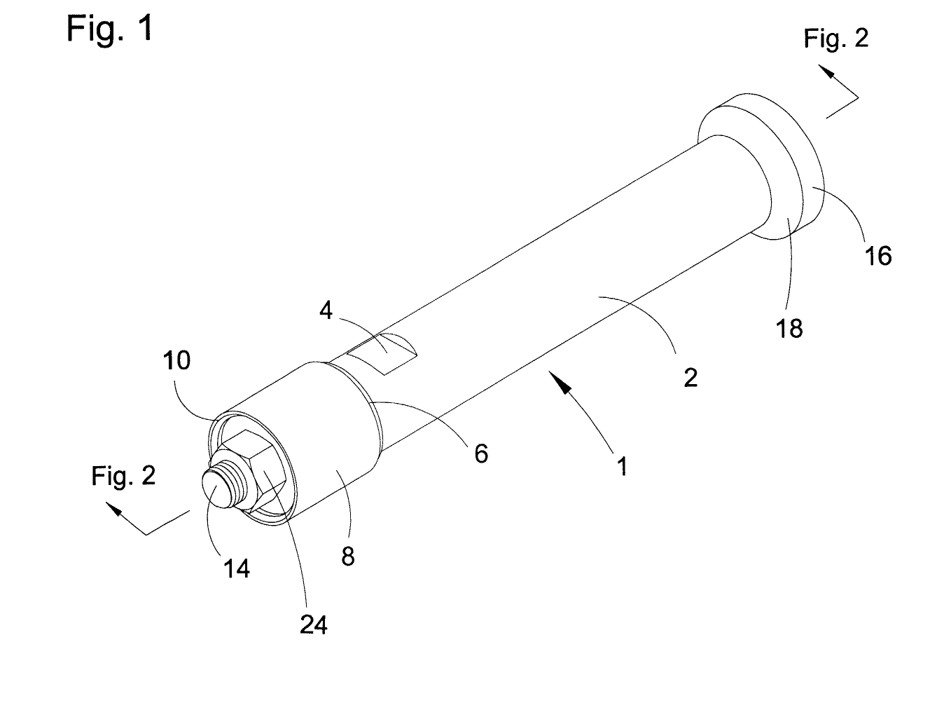

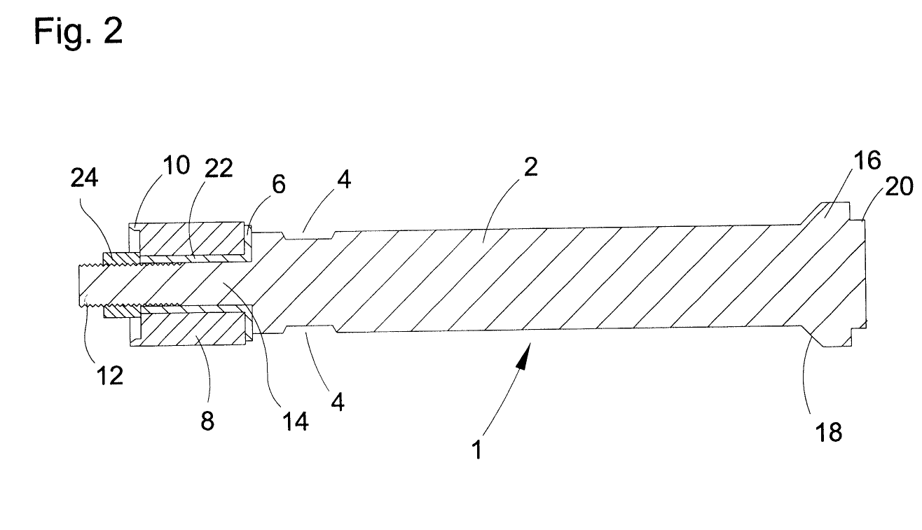

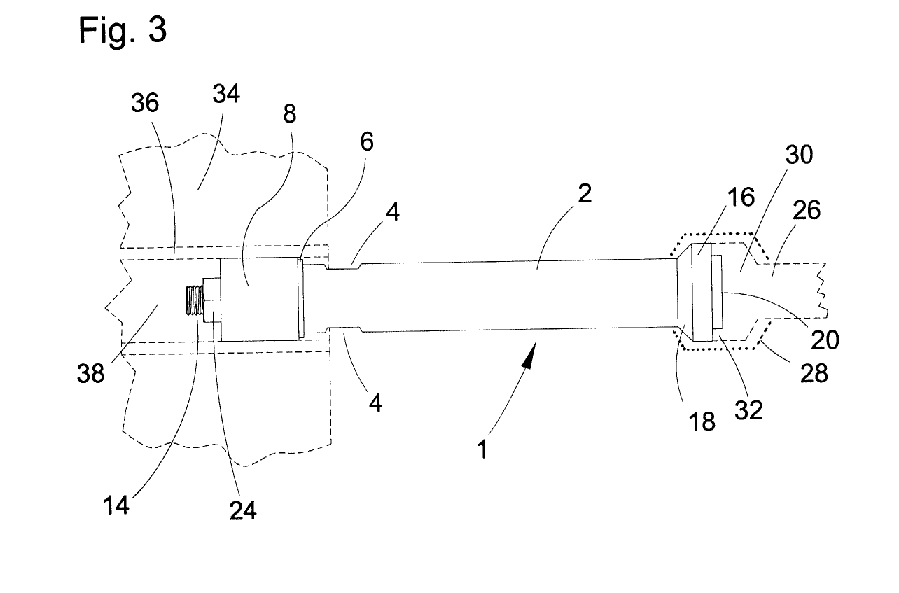

Referring now to the drawings, and in particular to FIG. 1, the instant inventive fluid driving implement is referred to generally by reference arrow 1. Such implement has a circular clamp ring engaging disk 16, such disk 16 having an annular forwardly facing and rearwardly chamfered face 18. Referring simultaneously to FIGS. 2 and 3, the rearward end of clamp ring 16 preferably forms a homogeneously attached rearwardly extending slide alignment lug 20.

Referring simultaneously to FIGS. 1 and 2, the implement 1 has a forward cylindrical piston support lug 14, the forward end of such lug 14 preferably including spiral threads 12. The forward end of the clamp ring engaging disk 16 and the rearward end of the piston support lug 14 are seamlessly linked by a homogeneous fusion 2, preferably configured as a bar or shaft, which extends the rearward end of piston support lug 14 forwardly from the forward end of clamp ring engaging disk 16. Preferably, opposing sides of shaft 2 are milled to form wrench jaw engaging lands 4.

Referring further simultaneously to FIGS. 1 and 2, a hollow bored piston or plunger 8 is mounted over a piston mounting sleeve 22. Preferably, the rearward end of the piston mounting sleeve 22 forms a radially outwardly extending piston driving flange 6. The inner annular surface of the piston mounting sleeve 22 is preferably closely fitted for mounting over piston support lug 14. A spirally threaded nut 24 is preferably threadedly mounted over the forward end of piston support lug 14, such nut 24 securely positioning piston mounting sleeve 22 and piston 8 in place. Preferably, the forward end of piston 8 forms an annular forwardly extending ridge 10 causing the forward end of the piston 8 to form a cupped or concave surface.

Referring to FIG. 3, in operation of the instant inventive fluid driving implement 1, the forward end 30 of one of the reciprocating slides 26 of a triplex drilling mud pump is placed in contact with and in alignment with the slide alignment lug 20 at the rearward end of clamp ring engaging disk 16. Upon such placement, a clamp ring 28 installed annularly around and spanning both the clamp ring engaging disk 16 and the forward end 30 of slide 26, compressively aligns and joins such elements.

Referring further to FIG. 3, a fluid head 34 of such triplex pump has a rearwardly opening cylinder sleeve 36 into which piston 8 is slidably inserted. Upon such insertion of piston 8, forward driving motion imposed upon slide 26 is transmitted to the forwardly facing surfaces of piston 8, such surfaces imposing pumping pressure upon drilling muds which flows?? into and fills the hollow bore 38 of cylinder sleeve 36.

Referring simultaneously to FIGS. 2 and 3, the homogeneous forward extension and linkage of the clamp ring engaging disk 16 and the piston support lug 14 allows forwardly directed driving pressure imposed upon such disk to be repeatedly applied to the implement 1 without resultant fracturing or bending of the implement.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope commensurate with the appended claims.

I claim:

1. A fluid driver for use in a triplex drilling mud pump, the fluid driver comprising:
(a) a piston support lug, the piston support lug having a forward end and a rearward end; and
(b) a clamp ring engaging disk, the clamp ring engaging disk having a forward end and a rearward end;
the forward end of the clamp ring engaging disk being homogeneously fused with the rearward end of the piston support lug, the homogeneous fusion extending the rearward end of the piston support lug forwardly from the forward end of the clamp ring engaging disk.

2. The fluid driver of claim 1 further comprising a piston and piston mounting means, the piston mounting means interlinking the piston and the piston support lug.

3. The fluid driver of claim 2 wherein the piston has a forward end, a rearward end, and a hollow bore extending through the piston from the forward end to the rearward end, and wherein the piston mounting means comprises a sleeve having an annular inner surface, an annular outer surface, a forward end, and a rearward end, the annular inner surface of the sleeve being fitted for slidable mounting over the piston support lug, the annular outer surface of the sleeve being fitted for mounting within the hollow bore of the piston.

4. The fluid driver of claim 3 wherein the rearward end of the sleeve forms an annular outwardly extending piston driving flange.

5. The fluid driver of claim 4 wherein the forward end of the piston support lug is spirally threaded, and wherein the piston mounting means further comprises a spirally threaded piston retaining nut threadedly mounted over the forward end of the piston support lug.

6. The fluid driver of claim 5 wherein the forward end of the piston forms a peripheral forwardly extending ridge.

7. The fluid driver of claim 6 further comprising a reciprocating slide aligning lug having a forward end and rearward end, the forward end of the said lug being homogeneously fused with the rearward end of the clamp ring engaging disk.

8. The fluid driver of claim 7 wherein the forward end of the clamp ring engaging disk is annularly rearwardly chamfered.

9. The fluid driver of claim 8 wherein the homogeneous forward extension of the piston support lug forms parallel wrench jaw engaging lands.

10. The fluid driver of claim 9 wherein the piston comprises vulcanized rubber.

11. The fluid driver of claim 10 wherein the piston support lug, the clamp ring engaging disk, and the homogeneous forward extension comprise steel.
